(19) United States
(12) Patent Application Publication
(10) Pub. No.: US 2019/0148883 A1
(43) Pub. Date: May 16, 2019

(54) Anti-Loose Socket

(71) Applicant: Suzhou A-Rack Enclosure Systems, Co., Inc., Suzhou, Jiangsu (CN)

(72) Inventor: ZhiYong Ding, Suzhou New District (CN)

(21) Appl. No.: 15/429,923

(22) PCT Filed: Feb. 9, 2016
(86) PCT No.: PCT/CN2016/100774

§ 371 Date: Feb. 10, 2017

(30) Foreign Application Priority Data
Jul. 28, 2016 (CN) 201610626234.6

(51) Int. Cl. H01R 13/639; H01R 13/627; H01R 13/58; H01R 24/20

(52) U.S. Cl. CPC H01R 13/639; H01R 13/627; H01R 24/20; H01R 13/5816; H01R 13/5812

(57) ABSTRACT

This invention discloses a kind of anti-disengaging socket including the body of socket (1). It has an elastic lock block (11), a rotary cam (12) and a shift lever (13) installed in the body of the socket (1) as its characteristics. The body of this socket has an anti-disengaging mechanism of plug preventing plug disengagement during usage. This invention is safe and reliable with a novel structure.

### TECHNICAL FIELD

This invention is involved in socket and specially concerned with a kind of anti-disengaging socket.

### BACKGROUND TECHNOLOGY

During the usage of sockets, the outage of electronic equipment frequently occurs because of the loose of socket resulted by some accidental factors and thus has a bad effect on the safe operation of electronic equipment.

### DETAILS OF INVENTIONS

The technical issues solved by this invention are to provide a kind of socket with safe and reliable shape, user-friendliness and anti-disengagement.

To solve the problems of current technology, this invention provides the technical solutions as below:
1. A kind of anti-disengaging socket containing the body of socket has elastic lock block, rotary cam and shift lever installed in the body of socket as described.
2. For optimization, a square hole is installed in the body of socket.
3. For optimization, a bar-type lock catch is installed in the body of socket.
4. For optimization, a square lock catch is installed in the body of socket.
5. For optimization, the number of elastic lock block is two.
6. For optimization, the number of bar-type lock catch is two.
7. For optimization, the number of square lock catch is one.
8. For optimization, a plug mounting hole and bar-type hole are installed in the body of socket.
9. For optimization, the material of the body of socket is plastic.

Compared with the solutions of existing technology, the advantages of this invention are:
1. In the technical solution of this invention, there is a plug anti-disengaging mechanism installed in the body of socket to prevent disengagement of socket during usage. It is safe and reliable with a novel structure.
2. In the technical solution of this invention, the lock catch adopted in anti-disengaging socket can mount and fix with other electronic equipment, which is convenient and fast for mounting.

### DESCRIPTION OF FIGURES

The following figures and implementation examples are for further description of this invention:

FIG. 1: implementation example of this invention, a schematic diagram of the structure of an anti-disengaging socket;

FIG. 2: implementation example of this invention, another schematic diagram of the structure of an anti-disengaging socket;

FIG. 3: implementation example of this invention, a front view of an anti-disengaging socket;

FIG. 4: implementation example of this invention, a top view of an anti-disengaging socket;

FIG. 5: implementation example of this invention, an axonometric drawing of an anti-disengaging socket;

Among: 1—body of socket, 11—elastic lock block, 12—rotary cam, 13—shift lever, 14—square hole, 15—bar—type lock catch, 16—square lock catch, 17—plug mounting hole, 18—bar—type hole.

### SPECIFIC IMPLEMENTATION METHOD

The following specific implementation examples are the further explanation to the solutions mentioned above. It is understood that these implementation examples are used to explain this invention but not limited to confine the scope of this invention. The implementation conditions adopted in the examples can be adjusted further according to the specific manufacturer. Unspecified implementation condition is usually the same as the condition in ordinary experiment.

### Implementation Examples

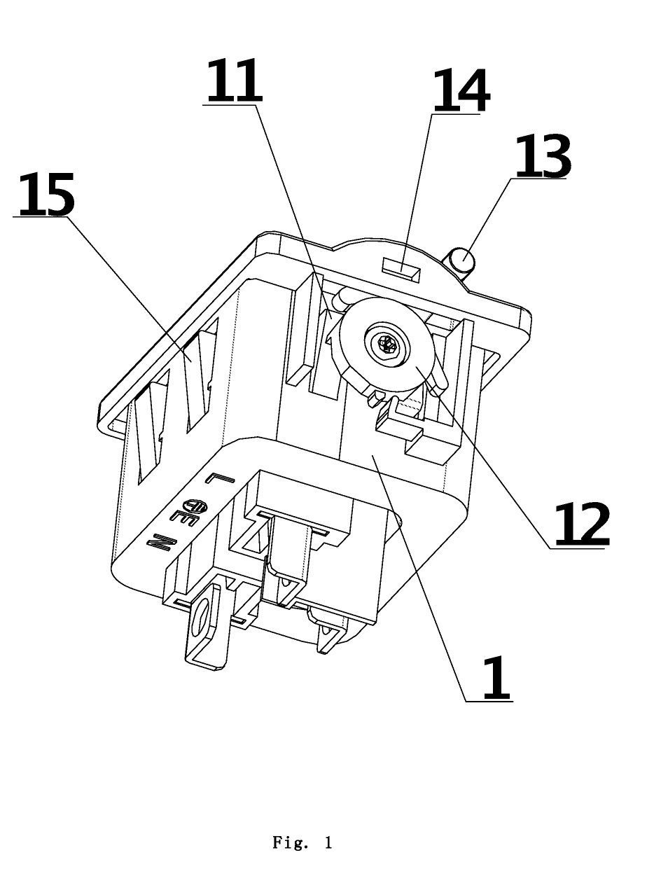

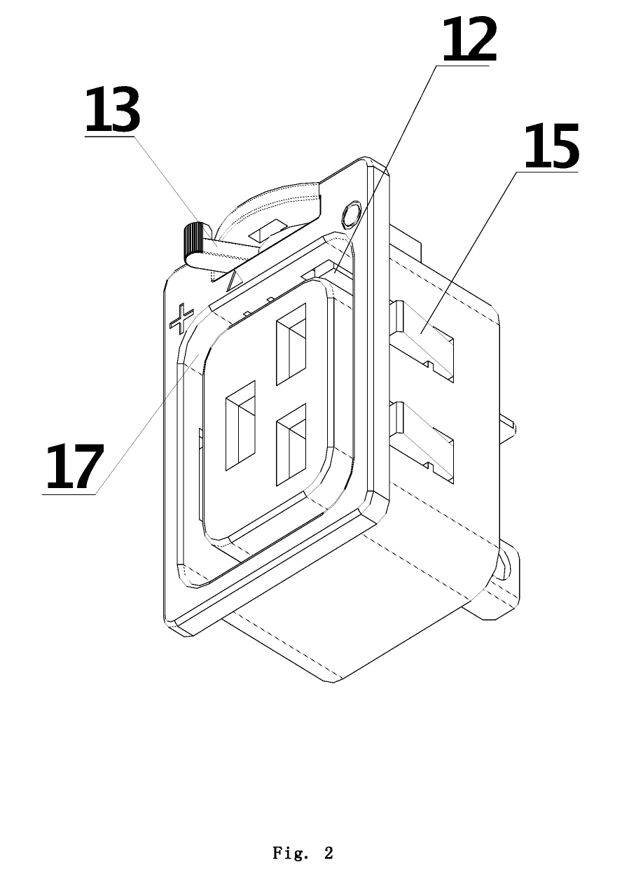

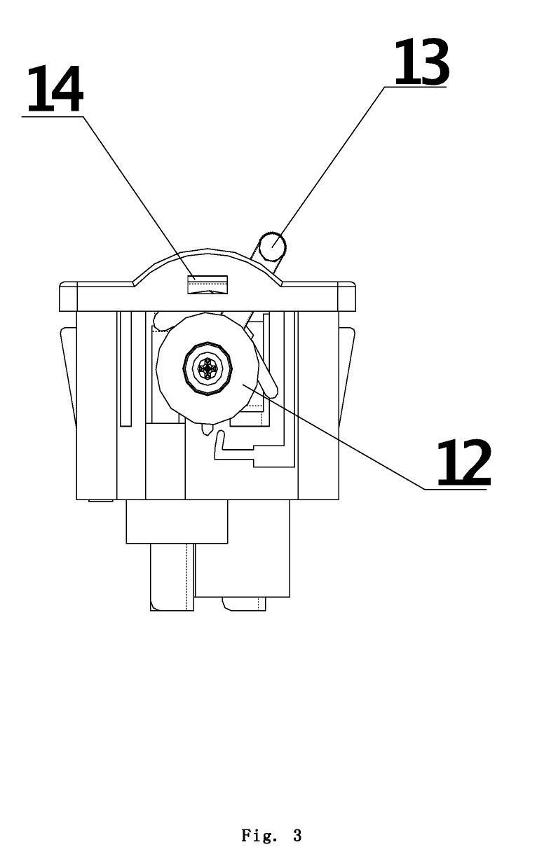

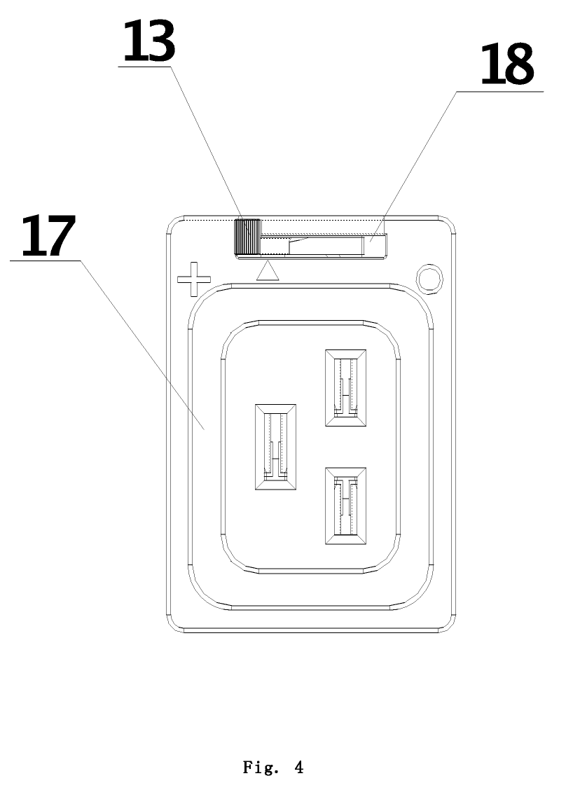

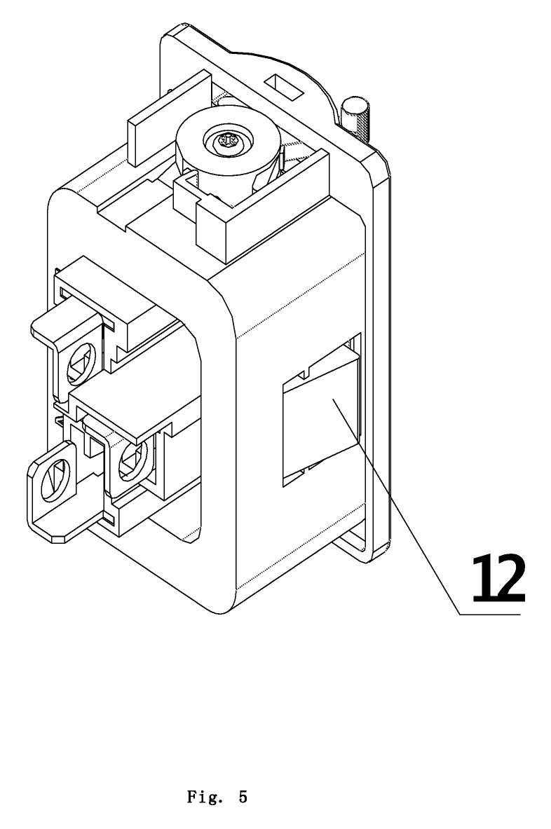

As illustrated in FIGS. 1 to 5, it is a kind of anti-disengaging socket containing the body of socket (1), and there is elastic lock block 11, rotary cam 12 and shift lever 13 installed in the mentioned body of socket.

Square hole 14 is installed in the body of socket 1.

Bar-type lock catch 15 is installed in the body of socket 1.

Square lock catch 16 is installed in the body of socket 1.

The number of elastic lock block is two.

The number of bar-type lock catch 15 is two.

The number of square lock catch 16 is one.

Plug mounting hole 17 and bar-type hole 18 are installed in the body of socket.

The material of the body of socket is plastic.

When using the anti-disengaging socket, fix the plug on the position of plug mounting hole 17 of the body of socket 1, make rotary cam 12 squeeze the elastic lock block 11 in the position of bar-type hole 18 through shift lever 13 and finally realize the function of anti-disengagement to the plug.

Meanwhile, realize the function of anti-disengagement to the power cord of plug through square hole 14 of the body of socket 1 by using binding wire.

The implementation examples are only for introducing the technical conception and characteristics of this invention. The purpose is to make people who are familiar with this technology can understand the content of this invention and make it into implementation, but not to confine the protection scope of this invention. Any equivalent transformation or modification based on the spiritual essence of this invention shall be covered by the protection scope of this invention.

What is claimed is:

1. A kind of anti-disengaging socket including the body of socket (1). Its characteristics lie in the elastic lock block (11), rotary cam (12) and shift lever (13) installed in the body of socket (1).

2. As to the anti-disengaging socket described in claim 1, its characteristic is that there is a square hole (14) on the top of the body of socket (1).

3. As to the anti-disengaging socket described in claim 1, its characteristic is that there is a bar-type lock catch (15) installed in the body of socket (1).

4. As to the anti-disengaging socket described in claim 1, its characteristic is that there is a square lock catch (16) installed in the body of socket (1).

5. As to the anti-disengaging socket described in claim 1, its characteristic is that there are two elastic lock blocks (11).

6. As to the anti-disengaging socket described in claim 1, its characteristic is that there are two bar-type lock catches (15).

7. As to the anti-disengaging socket described in claim 1, its characteristic is that there is one square lock catch (16).

8. As to the anti-disengaging socket described in claim 1, its characteristic is that a plug mounting hole (17) and a bar-type hole (18) installed in the body of socket (1).

9. As to the anti-disengaging socket described in claim 1, its characteristic is that the material of the body of socket (1) is plastic.
